(19) United States
(12) Patent Application Publication
(10) Pub. No.: US 2023/0356301 A1
(43) Pub. Date: Nov. 9, 2023

(54) POWDER BED FUSION ADDITIVE MANUFACTURING METHODS AND APPARATUS

(71) Applicant: RENISHAW PLC, Wotton-under-Edge, Gloucestershire (GB)

(72) Inventor: Ravi Guttamindapalli ASWATHANARAYANASWAMY, Gloucester (GB)

(73) Assignee: RENISHAW PLC, Wotton-under-Edge, Gloucestershire (GB)

(21) Appl. No.: 17/777,511

(22) PCT Filed: Dec. 14, 2020
(86) PCT No.: PCT/GB2020/053204

§ 371 Date: May 17, 2022

(30) Foreign Application Priority Data
Dec. 17, 2019 (GB) 1918601.4

(51) Int. Cl. B22F 10/50; B22F 10/28; B33Y 10/00; B33Y 40/20; B22F 10/364; B22F 12/45

(52) U.S. Cl. CPC B22F 10/50; B22F 10/28; B33Y 10/00; B33Y 40/20; B22F 10/364; B22F 12/45

(57) ABSTRACT

A powder bed fusion additive manufacturing method in which an object is built in a layer-by-layer manner. The method includes, for each layer of a plurality of successively fused layers, melting material of the layer by irradiating the layer with one or more energy beams a first time using a first set of irradiation parameters and allowing the melted material to solidify to define a fused region of the layer and reheating the fused region by irradiating the layer a subsequent time with one or more of energy beams using a second set of irradiation parameters. The first set of irradiation parameters includes at least one different irradiation parameter to the second set of irradiation parameters.

### FIELD OF INVENTION

This invention concerns powder bed fusion additive manufacturing methods and apparatus and, in particular, a method and apparatus for forming an object in a layer-by-layer manner by melting of powder of a powder bed.

### BACKGROUND

Powder bed fusion additive manufacturing methods for producing objects comprise layer-by-layer solidification of a powder, such as a metal powder material, using a high energy beam, such as a laser or electron beam. A powder layer is deposited on a powder bed in a build chamber and the laser or electron beam is scanned across portions of the powder layer that correspond to a cross-section of the object being constructed. The laser or electron beam melts the powder to form a solidified layer. After selective solidification of a layer, the powder bed is lowered by a thickness of the newly solidified layer and a further layer of powder is spread over the surface and solidified, as required.

U.S. Pat. No. 5,393,482 discloses a multiple laser sintering device including a sintering beam having a focal point at a powder bed and at least one defocused laser beam incident on a region near the focal point of the focused beam. The defocused beam raises the temperature of the material surrounding the sintering beam to a level below the sintering temperature, thereby reducing the temperature gradient between the sintering location and the surrounding material.

US2013/0064706 A1 discloses a scanner unit having a coupling mirror, wherein, via the coupling mirror, a diode laser beam supplied from the outside is brought into the beam path of the SLM or SLS laser beam. The diode laser beam is coupled into the SLM or SLS laser beam via the coupling mirror in such a manner that it strikes the powder layer at the same point and is guided on the powder layer along the same path as the SLM or SLS laser beam. Because the coupling mirror is arranged behind a focusing unit, only the SLM or SLS laser beam is focused, while the diode laser strikes the powder bed unfocused around the focus point of the SLM or SLS laser beam. As a result, the point on the powder bed is preheated in a site-selective manner by the diode laser beam. As an alternative to the use of the diode laser beam for preheating at the focus point of the SLM or SLS laser beam, it is also conceivable likewise to focus the diode laser beam at a focus point. The focused diode laser beam can then be guided before the SLM or SLM laser beam or after the SLM or SLS laser beam for the irradiation (and accordingly melting or sintering) of the powder layer.

US2011/0221099 A1 discloses a device for manufacturing a three-dimensional object, wherein the laser is controlled by means of the control unit in two different operating modes. The first operating mode causes a first pulsed radiation of the laser with a first frequency. The second mode of operation causes a second radiation, that is a pulsed radiation with a higher frequency compared to the first pulsed radiation or is a continuous radiation. First, the first pulsed electromagnetic radiation is irradiated onto a first area of a layer of the building material, and subsequently the second pulsed radiation or the continuous electromagnetic radiation is irradiated onto a second area of the layer of the building material. The first and second area of the layer overlap at least partially and may fully overlap. A time period is provided between the irradiation of the first pulsed electromagnetic radiation on the building material and the irradiation of the second pulsed or continuous electromagnetic radiation onto the building material, during which the building material irradiated with the first pulsed electromagnetic radiation solidifies.

WO2013/092994 A1 discloses apparatus for manufacturing a three-dimensional object by consecutively consolidating, layer-by-layer, selected areas of a powder stratum comprising at least partially preheating the powder layer using an electron beam power source and melting the powder with a laser-beam powder source.

US2015/0283612 A1 discloses three-dimensional moulding equipment including a plurality of light beam or electron beam scanning equipment. In one embodiment, the plurality of light beam or electron beam scanning equipment are synchronised such that radiated locations of the plurality of light beams or electron beams are moved along the same present scanning line, with a predetermined interval therebetween. In this way, sintering is gradually promoted, and thermal shock is small compared to a case in which a high-energy single light beam or electron beam is used.

WO2016/079496 A2 discloses an additive manufacturing apparatus comprising a laser source for generating a plurality of laser beams, a processor arranged to control the scanning unit to direct the laser beams to solidify a selected area of material by consecutively advancing multiple ones of the laser beams along a scan path. On a pass of each one of the laser beams along the scan path, the laser beam solidifies spaced apart sections of the scan path and a pass of one of the laser beams along the scan path solidifies sections that are located between sections of the scan path solidified by another of the laser beams.

US2016/0236299 A1 discloses a device for making a three-dimensional object by means of layer by layer consolidation of a powder-like construction material comprising a first irradiation source, such as a laser, which generates a laser beam, which is directed via a deflection device onto a layer of unconsolidated construction material. A selective heating device is provided, which is formed from a second radiation source together with another deflection device. The second radiation source can either generate electromagnetic radiation, i.e. it can be a laser, or it can generate particle radiation (such as electrons).

US2016/0250717 A1 discloses a method of producing a component in layers by laser melting. A molten pool is created in a bed of powder by a working laser beam. Further auxiliary laser beams are set to a power density that merely slows down the cooling of the material in one zone, but do not cause any renewed melting.

US2018/0141276 A1 discloses a method for additive manufacturing of a three-dimensional object by successive, selective layer-by-layer solidification of layers of a construction material by at least one energy beam. Heating of the construction material section(s) is carried out by at least one heating beam that can be brought together with a main laser beam, effecting a sintering or melting process of the construction material, such that both beams can be guided together and synchronously over the surface section to be heated or solidified. A focus of the main beam is guided either within the diameter of the heating beam or abutting against or directly adjacent to the diameter of the heating beam.

US2013/0233846 A1 discloses a method for generatively producing or for repairing at least one area of a component, wherein a zone arranged downstream of a molten bath is post-heated to a post-heating temperature. The powder is heated to the melting temperature in the front or first zone by means of a first laser beam. The rear or second zone is heated to a post-heating temperature by means of the second laser beam.

US2018/0257140 A1 discloses a device for the additive production of three-dimensional objects by successive, layered, selective irradiation and accompanying successive, layered, selective solidification of construction material. The device comprises a plurality of irradiation devices and makes it possible to selectively “allocate” different irradiation devices with different functions on the basis of corresponding control information generated by a control device. At least one irradiation device can be defined or operated as a first irradiation device, so that it generates an energy beam for the selective solidification of a construction material layer and at least one other irradiation device can be defined or operated as a second irradiation device so that it generates an energy beam for the thermal pre-treatment or post-treatment of a construction layer. The energy input of the second energy beam is so low that a melting of construction material is impossible with the second energy beam. The second energy beam can be guided tailing a first energy beam, to influence or control the cooling or solidification behaviour of the construction material.

US2018/0250744 A1 discloses a method of printing a three-dimensional object comprising (a) transforming a first-pre-transformed material to a first transformed material to print a layer of hardened material that is porous. The method further comprises using the energy beam to re-transform the transformed material to reduce or eliminate pores. A distance between two adjacent paths of the transforming energy beam (e.g. hatching) may be prescribed based on a requested porosity level.

“Impact of Process Conditions on the Properties of Additively Manufactured Tool Steel H13 processed by LBM”, L. Wu, T Klaas, S Leuders, F Brenne, T Niendorf, La Metallurgia Italiana, no. 3, 2018, page 12 to 19 discloses frequent observation of cracks in parts formed from tool steel H13. The cracks are assumed to be solidification cracks, which form primarily at boundaries between cellular grains with different orientations.

### SUMMARY OF INVENTION

According to a first aspect of the invention there is provided a powder bed fusion additive manufacturing method in which an object is built in a layer-by-layer manner, the method comprising, for each layer of a plurality of successively fused layers, melting material of the layer by irradiating the layer a first time with one or more energy beams using a first set of irradiation parameters and allowing the melted material to solidify to define a fused region of the layer and reheating the fused region by irradiating the layer a subsequent time with one or more of energy beams using a second set of irradiation parameters, wherein the first set of irradiation parameters comprises at least one different irradiation parameter to the second set of irradiation parameters.

It can be difficult to obtain a required fused microstructure when melting material in a powder bed fusion additive manufacturing method. For example, melting of the material may result in thermal conditions within and in the vicinity of the melt pool that result in undesired outcomes, such as undesired microstructure and/or solidification cracking. An amount of energy delivered to a region within a set time period and a rate at which heat is conducted away from the melt pool may depend on the geometry of an object being built and whether the melt pool is surrounded by powder or fused material. Attempting to regulate cooling through the addition of one or more further energy beams to achieve uniform cooling rates is complex, if possible at all, due to this complex thermal environment. The invention mitigates these problems by reheating the fused material to refine the microstructure formed initially when the melted material solidifies. The reheating increases a temperature of the fused region above a temperature at which grain refinement occurs. For example, the temperature may be a tempering temperature at which tempering of the fused material occurs, an annealing temperature (recrystallisation temperature) at which annealing of the fused material occurs, a solution heat treatment temperature at which a solution heat treatment of the fused material occurs, a sintering temperature at which sintering of the fused material occurs or a melting temperature at which melting of the fused material occurs. The reheating may increase a temperature of the fused region by at least 100° C., 200° C., 300° C., 400° C., and preferably by 500° C. The reheating may increase the temperature of the fused region above a martensite temperature of the material, for H13 tool steel 350° C. Reheating of the fused region may be carried out after the fused region has cooled to below 350° C.

In one embodiment, reheating of the fused region heats the fused material above a temperature at which grain refinement occurs but below the melting temperature, and preferably below the sintering temperature, of the material. In this way, irradiation of the layer the first time defines a shape of the fused material with irradiation of the layer the subsequent time refining the grain structure without modifying the shape.

In a further embodiment, reheating of the fused region heats the fused material above a sintering or melting temperature. It may be easier to determine a set of irradiation parameters that achieve the required melt pool conditions/fused microstructure if the melt pool is substantially surrounded by fused material connected to the fused material below.

The applicant believes that refining the grain structure through reheating of the fused material soon after the material has been melted reduces or eliminates solidification cracking. Solidification cracking is the formation of cracks in fused material during solidification of a melt pool. These cracks typically form at grain boundaries. It is believed that refining the grain structure to reduce the number of grain boundaries between differently oriented columnar or epitaxial grains will reduce solidification cracking. The invention may be particularly applicable to metal material, such as nickel-titanium, nickel-aluminium, nickel-titanium-aluminium alloys or tool steels. For example, the alloy may be a superalloy, such as Hastelloy, Inconel, Waspaloy, Rene alloys, Incoloy, CM247 or CMSX single crystal alloys. The tool steel may be a hot work tool steel, such as H13 or W360 tool steel or a high speed steel, such as M2. The alloy may be a titanium aluminide alloy.

The fused region may comprise a core of an object formed within the layer using the powder bed fusion additive manufacturing method. It will be understood that the term “core of an object” as used herein means a fused region of the layer that is formed (directly) on fused material of the previous layer and has fused material formed (directly) thereon through irradiation of the next layer, and excludes volumes melted using border scans used to form a hull in a hull and core irradiation strategy. Accordingly, the core excludes fused regions that form a surface (upskin or downskin) regions of the object. A core of an object is typically formed using “fill scan patterns”, which typically comprise a raster pattern in which parallel predefined irradiation paths (also referred to as “hatch lines”) are progressively irradiated with an energy beam.

The fused region may include, in addition to the core, upskin and/or downskin regions.

It will be understood that the term “each layer of a plurality of successively fused layers” means each powder layer that is successively fused and reheated through irradiating the material of that layer the first and the subsequent time and may correspond to each separately formed powder layer (for example, as spread by a powder recoater) or a powder layer comprising multiple separately formed powder layers that are fused together simultaneously, i.e. fused together as one thicker powder layer. For example, in a hull and core scanning strategy it is known to form a hull on each individually formed powder layer but to fuse the core through irradiation of the energy beams to fuse a thicker powder layer comprising multiple separately formed powder layers.

The same layer is (directly) irradiated the first and the subsequent time to melt and reheat the fused region. “Irradiating the layer” as used herein means directing a spot of the energy beam to an exposed surface of the layer before it is covered by a subsequent layer.

The method may comprise reheating the fused region more than one subsequent time. The method may comprise melting the fused material one or more subsequent times, wherein the melted material is allowed to solidify between the melting of material each of the subsequent times. The reheating of material each subsequent time may be with the same set or different sets of second irradiation parameters.

The fused region may by an entire cross-section of the object to be formed. The entire cross-section of the object to be formed may be fused through melting material of the layer before the entire cross-section is reheated. Alternatively, reheating of the fused region may begin before the entire cross-section to be solidified has been melted. This alternative may result in shorter build times.

The at least one different irradiation parameter is a user definable irradiation parameter for the energy beam and may be power of the energy beam, energy beam spot size (set by altering a focal position of the energy beam relative to the powder layer), energy beam spot shape, scan speed for continuous scanning of the energy beam over the powder layer or point distance and exposure time for modulated scanning of the energy beam over the powder bed, modulation frequency and/or a spacing between adjacent, parallel irradiation paths (hatch distance). Each of the first and second irradiation parameters may be same for a plurality of layers.

A separation between the first time and the (first) subsequent time may be greater than a predetermined minimum delay. A further separation between each subsequent time may be greater than the predetermined minimum delay. The predetermined minimum delay may be at least 250 microseconds and more preferably at least 500 microseconds. The predetermined minimum delay may allow the melted material to solidify before the fused material is reheated upon irradiation by the one or more energy beams the subsequent time. The separation between the first time and the (first) subsequent time may be less than a predetermined maximum delay. The further separation between each subsequent time may be less than the predetermined maximum delay. The maximum delay may be greater than 2500, greater than 3000, or greater than 5000 microseconds. In one embodiment, no maximum delay is set for the separation between the first and subsequent time and/or the further separation between the subsequent times. The maximum delay may be set such that a desired grain refinement, for example remelting, of the material is achieved with the trailing laser beam, which otherwise would not occur if a greater delay was used, for example because the energy density of the trailing laser beam alone is insufficient to cause such grain refinement/remelting.

The same irradiation pattern, e.g. the same irradiation paths and/or point exposures, may be used for irradiating the layer the first time and the or each subsequent time.

The irradiation pattern may comprise a hatch scanning strategy comprising an arrangement of a plurality of, typically parallel, predefined irradiation paths. Melting material of a powder layer may comprise progressively irradiating a predefined irradiation path with the or one of the energy beams. The irradiation paths may be spaced from each other such that irradiation of the irradiation paths with the one or more energy beams the first time results in a fused region with no unmelted powder between adjacent irradiation paths. Accordingly, any pores occurring within the fused material on melting of the fused material the first time are not caused by incomplete melting of powder material between the irradiation paths but, for example, by solidification cracking that occurs during solidification of the melt pool. Accordingly, any porosity that occurs in the fused region upon melting of the fused region the first time is not “designed in” through a spacing of the irradiation paths or a spacing of exposure points along the irradiation paths (which are selected to achieve a completely fused region) but is an observed consequence of the solidification process. The reheating of the fused material the subsequent time is carried out to close or prevent the formation of porous regions formed by solidification cracking.

Irradiation of the layer a first time may comprise progressively irradiating a predefined irradiation path with a first, leading energy beam and irradiating the fused region the or each subsequent time may comprise progressively irradiating the predefined irradiation path with a trailing energy beam. The leading energy beam and trailing energy beam(s) may be progressed along the irradiation path at the same speed (for example, for continuous or modulated scanning, by setting the scanning speed for the leading and trailing energy beams to be the same or, for modulated scanning, by setting the point distance and exposure time for the leading and trailing energy beams such that the same scanning speed is achieved for both energy beams (preferably, but not necessarily, by setting the leading and trailing energy beams to have the same point distance and exposure time)).

The leading energy beam may have a different power to the trailing energy beam(s). For example, the trailing energy beam(s) may have a power that is less than three-quarters and preferably, less than a half of the power of the leading energy beam. The trailing energy beam(s) may have a spot size the same as or larger than the leading energy beam. The trailing energy beam(s) may be defocused relative to the leading energy beam. An energy density of the trailing energy beam at the layer may be less than an energy density of the leading energy beam.

The second irradiation parameters and/or the separation between the leading and trailing energy beam may be such that the trailing energy beam reheats the fused region and powder around the fused region. For example, the trailing energy beam may reheat powder that is to be melted by the leading energy beam on progression of the leading energy beam along an adjacent irradiation path. This may be beneficial as the preheating of the powder may help to reduce thermal shock when the powder is melted.

In another embodiment, reheating of the fused region comprises progressively irradiating a further predefined irradiation path with the or one of the energy beams different to the predefined irradiation path.

The further irradiation pattern may be arranged to form a preferential direction for grain formation, such as described in EP19179230.8, which is incorporated herein by reference in its entirety.

In another embodiment, the further irradiation pattern comprises a distributed scanning strategy, wherein sections are irradiated non-continuously and in an order such that consecutively irradiated sections are spaced apart, such as described in WO2016/079496, which is incorporated herein by reference in its entirety. The sections may be irradiated to form melt pools in conduction or transition mode rather than keyhole mode.

The method may comprise carrying out a first scanning strategy such as a hatch scanning strategy, to melt the material the first time and carrying out a different, second scanning strategy, such as a distributed scanning strategy. to melt the material the, a one of, or each subsequent time. A first scanning strategy may result in undesired microstructure but provide a rapid way of forming a foundation to use in forming the desired microstructure using a different scanning strategy, such as a distributed scanning strategy.

The method may comprise melting of the fused region the, a one of or each subsequent time such that the melt pool(s) formed extend shallower than the melt pool(s) formed when melting material of the layer the first time to form the fused region. In this way, melting of the fused region the subsequent time may fix cracks formed in the layer when melting the material, the first time without initiating the formation of further porous regions through high-powered irradiations, which may cause material to be vaporised. For example, melt pools formed by melting of the fused material the or each subsequent time may be formed in a transition or conduction mode.

It will be understood that “conduction mode” as used herein means that the energy of the energy beam is coupled into the powder bed primarily through heat conduction creating a melt pool having a width greater than its depth. This is to be contrasted with keyhole mode in which a hole is formed in the melt pool where material is vaporised by exposure to the energy beam. A melt pool formed in keyhole mode has a deep, narrow profile with a ratio of depth to width of greater than 1.5. A transition mode exists between the conduction mode and the keyhole mode, wherein the energy does not dissipate quickly enough and the processing temperature rises above the vaporisation temperature. A depth of the melt pool increases and penetration of the melt pool can start. The melt pools formed in a conduction or transition mode have a depth to width ratio of less than 1.5, preferably, less than 1, more preferably less than 0.75 and most preferably less than or equal to 0.5.

Alternatively, the method may comprise melting of the fused region the or each subsequent time such that the melt pool(s) formed extend deeper than the melt pool(s) formed when melting material of the layer the first time to form the fused region. In this way, melting of the fused region the or each subsequent time “over-writes” the microstructure formed when melting the material of the fused region the first time such that the final microstructure of the object is defined by the scanning parameters and/or scanning strategy used for the melting the fused material the subsequent time. A depth of the melt pool(s) formed by melting the material the first time may be less than the thickness of five, four or three layers and preferably less than or approximately equal to the thickness of two layers but preferably greater than or equal to the thickness of one layer. In this way, melting of the material the first time forms solid connections with the underlying solidified material but is shallow enough to enable it to be overwritten by the or each subsequent exposure. The energy beam parameters for melting of material the subsequent time, and optionally both the first time and the subsequent time, may be configured such that melt pools are formed in conduction or transition mode.

According to a second aspect of the invention there is provided a powder bed fusion additive manufacturing method in which an object is built in a layer-by-layer manner, the method comprising, for each layer of a plurality of successively fused layers, melting material of the layer using a leading energy beam by progressing the energy beam over the material along an irradiation path, allowing the melted material to solidify and reheating the solidified material by progressing a trailing energy beam along the irradiation path.

The leading energy beam may be progressed along the irradiation path using a first set of irradiation parameters and the trailing energy beam may be progressed along the irradiation path using a second, different set of irradiation parameters. The second set of irradiation parameters may comprise a different energy beam power and/or spot size on the layer. The trailing energy beam may have a larger spot size than the leading energy beam. The trailing energy beam may be irradiated at a lower power than the leading energy beam. The trailing energy beam provide a lower energy density that the leading energy beam. The second set of irradiation parameters may be selected such that the trailing energy beam reheats the solidified material to above a grain refinement temperature such as a tempering temperature, an annealing temperature (recrystallisation temperature), a solution heat treatment temperature, a sintering temperature or a melting temperature. The reheating may increase a temperature of the solidified material by at least 100° C., 200° C., 300° C., 400° C., and preferably by at least 500° C. Reheating of the solidified material may be carried out after the solidified material has cooled to below 350° C.

A separation time between the leading energy beam and the trailing energy beam may be nominally fixed and/or may be greater than a predetermined minimum delay. The predetermined minimum delay may be at least 250 microseconds and more preferably at least 500 microseconds. The predetermined minimum delay allows the melted material to solidify such that the fused material is reheated upon irradiation of the layer by one or more the energy beams the subsequent time. The separation between the leading energy beam and the trailing energy beam may be less than a predetermined maximum delay. The maximum delay may be greater than 2500 microseconds.

According to a third aspect of the invention there is provided a powder bed fusion additive manufacturing method in which an object is built in a layer-by-layer manner, the method comprising, for each layer of a plurality of successively fused layers, melting material of the layer a first time by irradiating the layer in a first irradiation pattern with one or more energy beams, allowing the melted material of the pattern to solidify to define a fused region of the layer and melting the fused region a subsequent time in a second irradiation pattern with one or more energy beams.

The second irradiation pattern may be different from the first irradiation pattern. Accordingly, melting of the fused region the subsequent time may change the overall microstructure of the fused material from that achieved by melting the material the first time. The second pattern may be arranged to achieve a directional grain structure, such as described in PCT/GB2020/051382, which is incorporated herein in its entirety by reference.

The fused region may comprise a core of an object.

According to a fourth aspect of the invention there is provided a powder bed fusion additive manufacturing method in which an object is built in a layer-by-layer manner, the method comprising, for each layer of a plurality of successively fused layers, melting material of the layer by irradiating the material a first time using a leading energy beam by progressing the energy beam over the material along an irradiation path, and irradiating the material a subsequent time by progressing a trailing energy beam over the fused material along the irradiation path, wherein a separation time between the leading energy beam and the trailing energy beam is at least 500 microseconds.

The predetermined minimum delay allows the fused material to sufficiently cool such that the fused material is reheated upon irradiation by the trailing energy beam. The separation between the leading energy beam and the trailing energy beam may be less than a predetermined maximum delay. The maximum delay may be greater than 2500 microseconds. In one embodiment, no maximum delay is set between the first and subsequent time.

According to a fifth aspect of the invention there is provided a powder bed fusion apparatus comprising a build platform for supporting a powder bed, a layer formation device for forming powder layers of the powder bed, a scanner for directing one or more energy beams to a working surface of the powder bed, and a controller arranged to control the layer formation device and the scanner to carry out the method according to any one of the first, second, third and fourth aspects of the invention.

According to a sixth aspect of the invention there is provided a controller for controlling a powder bed fusion apparatus comprising a build platform for supporting a powder bed, a layer formation device for forming powder layers of the powder bed and a scanner for directing one or more energy beam to a working surface of the powder bed, the controller arranged to control the layer formation device and the scanner to carry out the method according to any one of the first, second, third and fourth aspects of the invention.

According to a seventh aspect of the invention there is provided a data carrier having instructions stored thereon, which, when executed by a processor of a controller of a powder bed fusion apparatus comprising a build platform for supporting a powder bed, a layer formation device for forming powder layers of the powder bed and a scanner for directing one or more energy beams to a working surface of the powder bed, cause the controller to control the layer formation device and the scanner to carry out the method according to any one of the first, second, third and fourth aspects of the invention.

According to a eighth aspect of the invention there is provided a method for generating a build programme for a powder bed fusion apparatus comprising a build platform for supporting a powder bed, a layer formation device for forming powder layers of the powder bed, a scanner for directing one or more energy beams to a working surface of the powder bed and a controller for controlling the layer formation device and the scanner, the method comprising receiving geometric data defining an object, determining slices of the object to be formed in layers in the powder bed fusion apparatus, determining an irradiation sequence for the one or more energy beams in order to carry out the powder bed fusion additive manufacturing method according to any one of the first, second, third and fourth aspects of the invention and generating a build programme, which, when executed by the controller causes the controller to control the layer formation device and the scanner to carry out the powder bed fusion additive manufacturing method.

According to a ninth aspect of the invention there is provided a data carrier having instructed thereon, which, when executed by a processor, cause the processor to carry out the method according to the ninth aspect of the invention.

The data carrier may be a suitable medium for providing a machine with instructions such as non-transient data carrier, for example a floppy disk, a CD ROM, a DVD ROM/RAM (including −R/-RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example signals sent over a wired or wireless network (such as an Internet download, an FTP transfer, or the like).

### DESCRIPTION OF THE DRAWINGS

FIG. 1 is a schematic diagram of a powder bed additive manufacturing apparatus according to an embodiment of the invention;

FIG. 2 is a plan view of the powder bed additive manufacturing apparatus shown in FIG. 1;

FIG. 3 is a schematic illustration of a scanning strategy according to a first embodiment of the invention;

FIG. 4 is a cross-section of fused layers illustrating a core, upskin and downskin regions of an object;

FIG. 5 is a schematic illustration of a scanning strategy according to a second embodiment of the invention;

FIG. 6 is a schematic illustration of a scanning strategy according to a third embodiment of the invention;

FIG. 7 is a schematic illustration of melt pools formed using the scanning strategy of the third embodiment;

FIG. 8 is a back-scattered electron image of a cross-section of a cube formed from H13 tool steel using a single laser beam;

FIG. 9 is a back-scattered electron image of a cross-section of a cube formed from H13 tool steel using leading and trailing laser beams, wherein a 200 W trailing laser beam trials the leading laser beam by 2500 μs;

FIG. 10 is a back-scattered electron image of a cross-section of a cube formed from H13 tool steel using leading and trailing laser beams, wherein a 100 W trailing laser beam trials the leading laser beam by 2500 μs;

FIG. 11 is a back-scattered electron image of a cross-section of a cube formed from H13 tool steel using a leading laser beam and three trailing laser beams, wherein each trailing laser beam follows the preceding laser beam by 500 μs;

FIG. 12 is a back-scattered electron image of a cross-section of a cube formed from H13 tool steel using a leading laser beam and three trailing laser beams, wherein each trailing laser beam follows the preceding laser beam by 1000 μs;

FIG. 13 is a back-scattered electron image of a cross-section of a cube formed from H13 tool steel using a leading laser beam and three trailing laser beams, wherein each trailing laser beam follows the preceding laser beam by 1500 μs;

FIG. 14 are tables showing the scan parameters used for the laser beams of Example 4;

FIGS. 15a and 15b are histograms showing the number of differently sized cracks found in the cubes built in the manner described in Example 4;

FIGS. 16a and 16b are a back-scattered electron image of cross-sections of a cube formed from H13 tool steel using a single laser beam, wherein the powder bed has been heated to 500° C.;

FIGS. 17a and 17b are a back-scattered electron image of cross-sections of a cube formed from H13 tool steel using leading and trailing laser beams (without heating the powder bed to 500° C.);

FIGS. 18a and 18b are a back-scattered electron image of cross-sections of a cube formed from H13 tool steel using a single laser beam (without heating the powder bed to 500° C.);

FIG. 19 is a table showing the scan parameters used for the laser beams of Example 6 in which cubes and tracks were formed from M2 high-speed steel;

FIGS. 20-1 to 20-7 show solidified hatch lines formed with laser beams having the scan parameters set out in FIG. 19;

FIGS. 21a and 21b are a back-scattered electron images of top surfaces of the cubes formed from M2 high-speed steel using leading and trailing laser beams (FIG. 21a) and a single laser beam (FIG. 21b); and

FIG. 22 is a back-scattered electron image of a cross-section of a cube formed from M2 high-speed steel using leading and trailing laser beams parallel to the build direction, wherein a hatch formation direction is normal to the page.

### DESCRIPTION OF EMBODIMENTS

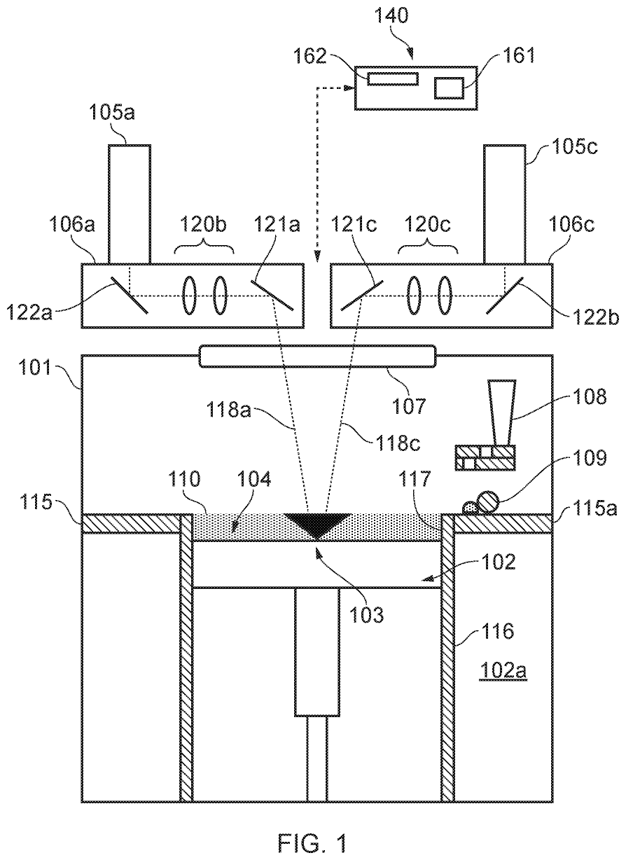

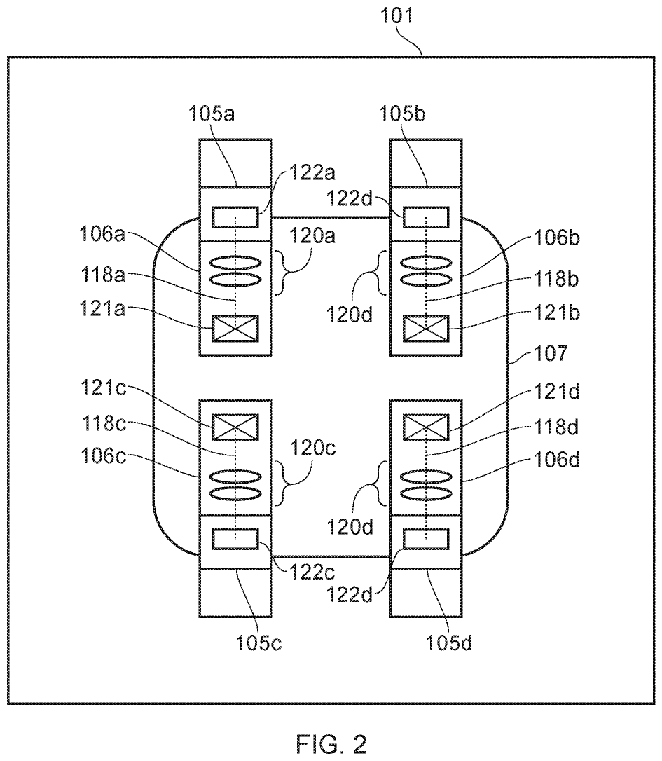

Referring to FIGS. 1 and 2, a powder bed fusion additive manufacturing apparatus according to an embodiment of the invention comprises a build chamber 101 having therein partitions 115, 116 that define a build volume 117. A build platform 102 is lowerable in the build volume 117. The build platform 102 supports a build substrate plate 102a, a powder bed 104 and workpiece 103 as the workpiece is built by selective laser melting of the powder. The platform 102 is lowered within the build volume 117 under the control of a motor (not shown) as successive powder layers are formed.

Layers of powder 104 are formed as the workpiece 103 is built by dispensing apparatus 108 and a wiper 109. For example, the dispensing apparatus 108 may be apparatus as described in WO2010/007396. The dispensing apparatus 108 dispenses powder onto an upper surface 115a defined by partition 115 and is spread across the powder bed by recoater, in this embodiment in the form of wiper 109. A position of a lower edge of the wiper 109 defines a working surface/plane 110 at which powder is consolidated.

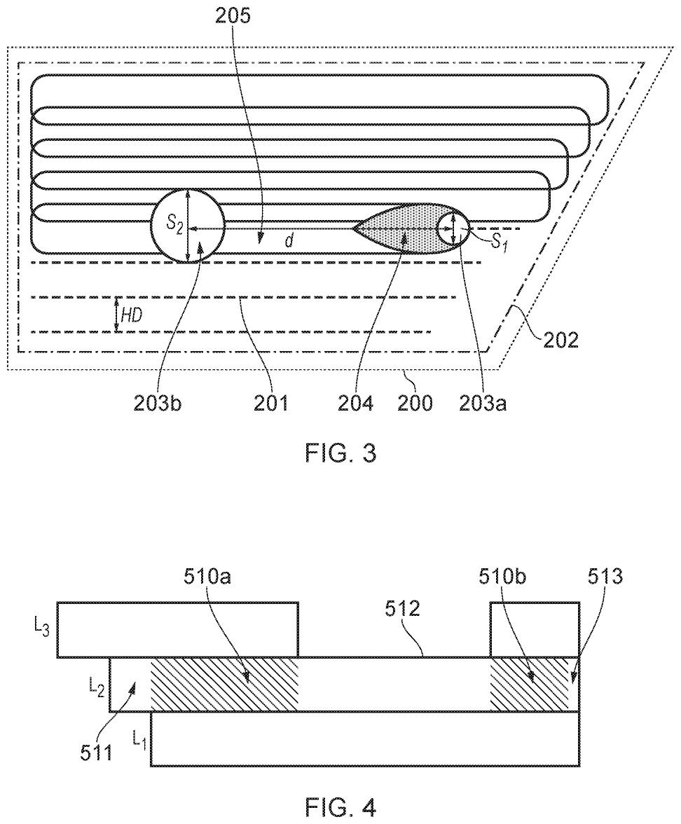

A plurality of laser modules 105a, 105b, 105c and 105d generate laser beams 118a, 118b, 118c, 118d for irradiating the powder bed 104, the laser beams 118a, 118b, 118c, 188d steered as required by a corresponding optical module 106a, 106b, 106c, 106d. The laser beams 118a, 118b, 118c, 118d are steered by the corresponding optical module to enter the build chamber 101 through a common laser window 107. Each optical module comprises steering optics 121, such a two mirrors 141a, 141b mounted on galvanometers 124a, 124b (see FIG. 3), for steering the laser beam 118 in perpendicular directions, X and Y, across the entire working plane 110 and focusing optics 120, such as two movable lenses for changing the focus of the laser beam 118. The optical modules 106a, 106b, 106c, 106d are shown here as separate but they may be combined together into a single-piece housing, as is the case in Renishaw's RenAM 500Q additive manufacturing machine. Each scanner is controlled such that the focal position of the laser beam 118 remains in the same plane 110 as the laser beam 118 is moved across the working plane 110. Rather than maintaining the focal position of the laser beam in a plane using dynamic focusing elements, an f-theta lens may be used.

A controller 140, comprising processor 161 and memory 162, is in communication with modules of the additive manufacturing apparatus, namely the laser modules 105a, 105b, 105c, 105d, optical modules 106a, 106b, 16c, 106d, build platform 102, dispensing apparatus 108 and wiper 109. The controller 140 receives build instructions from an external computer having build preparation software thereon and controls each of the modules based upon the build instructions in order to build one or more objects using an additive manufacturing process. The build preparation software may be as described in WO2014/207454 but further adapted to generate build instructions implementing the scanning strategies as described below.

Referring to FIG. 3, a scanning strategy for consolidating powder material to form a cross-section 200 of an object comprises melting material of a powder layer L₅ by progressively irradiating a predefined irradiation path 201 with a first, leading laser beam 203a and reheating the fused region 205 by progressively irradiating the predefined irradiation path 201 with a trailing laser beam 203b. In this embodiment, the leading laser beam 203a and trailing laser beam 203b are continuously scanned along the parallel irradiation paths 201 (also called hatch lines) at the same speed. The hatch lines are spaced a hatch distance HD apart such that adjacent solidified lines form a continuous fused region with no powder therebetween. Parallel hatch lines 201 are typically used as a fill scan to solidify a core of a cross-section and one or more border scans 202 are carried out to provide a hull around the core.

An example of a core of a layer L₂ of fused material is illustrated in FIG. 4 by the shaded areas 510a and 510b. Shaded areas 510a and 510b are formed directly on fused material of the layer L₁ below and have fused material formed thereon when the layer L₃ above is fused. Accordingly, region 511 is not part of a core of layer L₂ because it is a downskin region not directly formed on fused material (but fused on powder), region 512 is not part of a core of layer L₂ because it is an upskin region on which no fused material of layer L₃ is formed and region 513 is a border region fused through irradiating this region using a border scan.

The fill scan may comprise a meander scan pattern in which all of the hatch lines are in the same direction (although they be scanned bi- or unidirectionally), a chequerboard scan pattern, wherein the cross-section to be solidified is split into a plurality of squares, each square comprising a plurality of hatch lines, wherein a direction of the hatch lines between squares may differ, for example by 90° or a stripe scan pattern, wherein the cross-section to be solidified is split into a plurality of parallel stripes, each stripe comprising a plurality of hatch lines. The chequerboard and stripe scan patterns may provide equal length hatch lines, except in circumstances wherein a square or stripe is curtailed due to a border of the cross-section 200 to be solidified.

The border scans 202 may use a different set of parameters to the fill scans, for example such that a desired surface finish is achieved. The border scans may also be scanned with leading and trailing laser beams or may be scanned with only a single laser beam.

The leading and trailing laser beams 203a, 203b are separated by a delay, d, such that material 204 melted by the leading laser beam 203a is allowed to solidify before the fused material 205 is reheated by the laser beam 203b. In this embodiment, the delay. d, is greater than 250 microseconds and preferably 2500 microseconds. The set of irradiation parameters for the leading and trailing laser beams are also different. In this embodiment, the leading laser has a smaller (1/e²) spot size, S₁, and high power than the trailing laser beam 203a. The larger spot size S₂ of the trailing laser beam 203b may be achieved by defocusing the laser beam, for example by focusing the laser beam to a plane above or below a working surface of the powder bed 104.

An energy density provided by the trailing laser beam 203a may be insufficient to melt the material but may heat the material above a temperature at which a grain refinement occurs.

Alternatively, an energy density provided by the trailing laser beam 203a may be sufficient to melt the material resulting in a grain refinement. In this alternative embodiment, the energy density of the trailing laser beam alone may be insufficient to melt the material to form a continuous hatch line of solidified material. However, in conjunction with the leading laser beam, the delay between the leading and trailing laser beam is long enough for the material melted by the leading laser beam to solidify but shorter enough that sufficient heat remains within the locality such that the trailing laser beam remelts the material.

It has been found that this scanning strategy reduces a number of cracks in the resultant object compared to using only a single laser beam. It is believed the reheating of the fused material by the trailing laser beam 203b refines the grains to reduce an amount of equiaxed and/or columnar grains, thus reducing boundaries between differently oriented equiaxed and columnar grains. The reduction in such grain boundaries, reduces an amount of solidification cracking in the metal material. It has been found that such a scanning strategy is capable of reducing cracking to such an extent that builds that previously failed due to cracking can now be built.

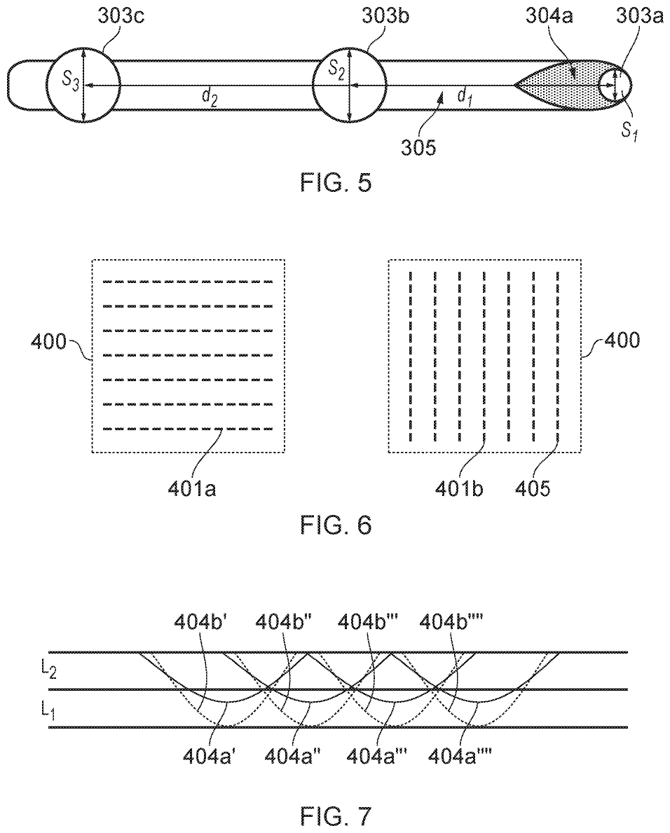

Referring to FIG. 5, a further scanning strategy is shown. This embodiment differs from the embodiment described with reference to FIG. 3 in that an additional trailing laser beam 303c is provided. The additional trailing laser beam 303c reheats the fused region 205 a third time by progressively irradiating the predefined irradiation path 201 a set delay, d₂, after the trailing laser beam 303b. The delay, d₂, may be the same of different from delay, d₁.

It has been found that the addition of a further trailing laser beam further reduces cracks in the resultant object compared to using a leading laser beam and one trailing laser beam. In this embodiment, the set of irradiation parameters used for the additional trailing laser beam 303c is different to that used for the trailing laser beam 303b.

Referring to FIGS. 6 and 7, a scanning strategy for consolidating powder material to form a cross-section 400 of an object comprises melting material a first time with a first scan pattern comprising a first set of exposures, in this embodiment hatch lines 401a, allowing the melted material to solidify to form an entire fused cross-section 400 of the object and then melting the material of the fused cross-section 400 a second time using a second scan pattern comprising a second set of exposures, in this embodiment a second set of hatch lines 401b. The hatch lines of the second set of exposures may be in the same direction as the first set of exposures or may be in a different direction to the first set of exposures, as shown in FIG. 6.

The first set of exposures form melt pools 404a′, 404a″, 404a′″ and 404a″″ that are sufficiently deep to consolidate the fused material with fused material of the layer below but are shallower than then melt pools 404b′, 404b″, 404b′″ and 404b″″ formed by the second set of exposures. In this way, the second set of exposures “overwrite” the first set of exposures such that the resultant grain structure is primarily a consequence of the solidification rate and geometry of the melt pools formed by the second set of exposures. The fused material formed by the first set of exposures provides a uniform environment such that the second set of exposures form melt pools having the required shape and inter-relation to achieve a directional grain structure. This can be important when forming an object having a preferred grain direction, as is described in EP19179230.8.

In this embodiment, both the first and second sets of the exposures form melt pools in a conduction or transition mode.

### Example 1

Eight 10 mm×10 mm×10 mm cubes were built from tool steel HS13 powder in a RenAM 500Q additive manufacturing machine. The cubes were built using a meander scan strategy, wherein the hatch direction was rotated every layer by 67 degrees. No preheating of the powder was carried out using the heater in the build platform. Seven of the cubes were built using leading and trailing laser beams and one of the cubes was built using a single laser beam. The scan parameters are set out below.

### Single Laser

A cube was built using a single laser beam with the following scan parameters:
Laser Power: 200 W
Focal point relative to working plane: 0 mm
Point distance: 20 μm
Exposure time: 20 μs
Hatch distance: 0.08 mm

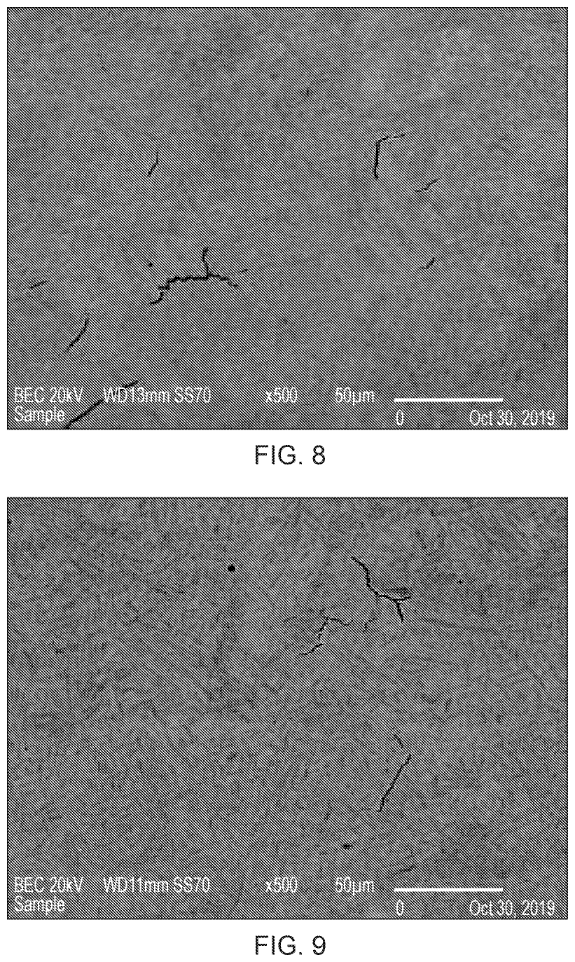

FIG. 8 illustrates a back-scattered electron image of a cross-section of the cube formed using these scan parameters. As can be seen from the image, a number of large cracks are present in the fused material.

### 200 W Trailing Laser

A cube was built using leading and trailing laser beams, wherein the trailing laser beam trailed by 2500 μs. The following scan parameters were used:

### Leading Laser Beam:

Laser Power: 200 W
Focal point relative to working plane: 0 mm
Point distance: 20 μm
Exposure time: 20 μs
Hatch distance: 0.08 mm

### Trailing Laser Beam:

Laser Power: 200 W
Focal point relative to working plane: +5 mm
Point distance: 20 μm
Exposure time: 20 μs
Hatch distance: 0.08 mm

FIG. 9 illustrates a back-scattered electron image of a cross-section of the cube formed using these scan parameters. As can be seen from the image, the number and size of cracks present in the fused material have reduced compared to the cube formed using a single laser. A refinement of the grain structure can be observed in the image compared to building the cube using a single laser beam.

### 100 W Trailing Baser Beam

A cube was built using leading and trailing laser beams, wherein the trailing laser beam trailed by 2500 μs. The following scan parameters were used:

### Leading Laser Beam:

Laser Power: 200 W
Focal point relative to working plane: 0 mm
Point distance: 20 μm
Exposure time: 20 μs
Hatch distance: 0.08 mm

### Trailing Laser Beam:

Laser Power: 100 W
Focal point relative to working plane: +5 mm
Point distance: 20 μm
Exposure time: 20 μs
Hatch distance: 0.08 mm

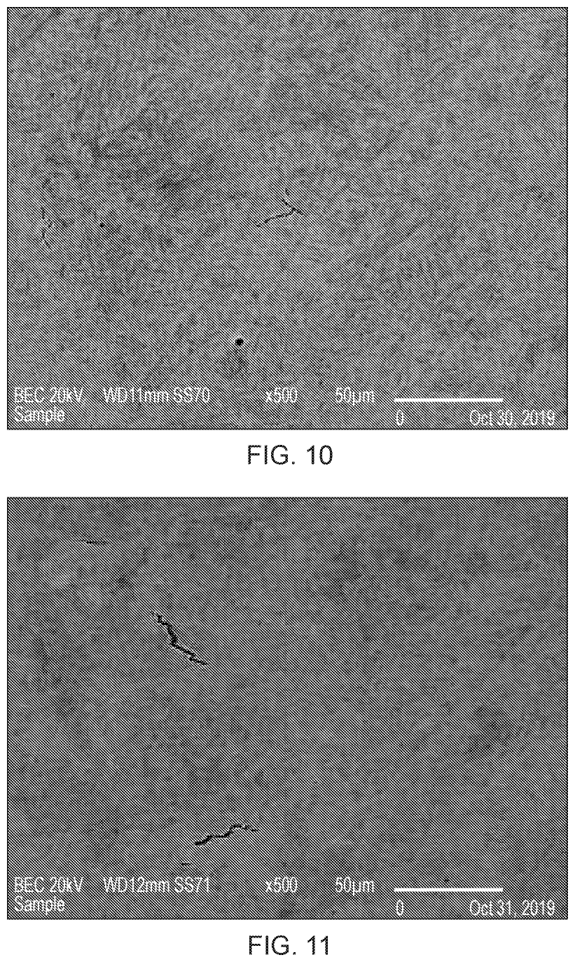

FIG. 10 illustrates a back-scattered electron image of a cross-section of the cube formed using these scan parameters. As can be seen from the image, the number and size of cracks present in the fused material have reduced compared to the cube formed using a single laser beam and the cube formed using a 200 W trailing laser beam. Again, a refinement of the grain structure was apparent compared to the cube formed using single laser beam.

An increase in the hardness of the material formed using leading and trailing laser beams over that formed using a single laser beam was also observed, which also is an indication that a refinement of the grain structure has occurred as a result of the heat treatment using the trailing laser beam.

### Example 2

Three 10 mm×10 mm×3 mm cubes were built from tool steel HS13 powder in a RenAM 500Q additive manufacturing machine using a leading laser beam and three trailing laser beams. For a first one of the cubes, the delay time between each laser beam was 500 μs, for a second one of the cubes, the delay time between each laser beam was 1000 μs and for a third one of the cubes, the delay time between each laser beam was 1500 μs. The cubes were built using a meander scan strategy, wherein the hatch direction was rotated every layer by 67 degrees. No preheating of the powder was carried out using the heater in the build platform. The scan parameters are set out below.

### Leading Laser Beam:

Laser Power: 240 W
Focal point relative to working plane: 0 mm
Point distance: 20 μm
Exposure time: 20 μs
Hatch distance: 0.08 mm

### 1^{st} Trailing Laser Beam:

Laser Power: 150 W
Focal point relative to working plane: +15 mm
Point distance: 20 μm
Exposure time: 20 μs
Hatch distance: 0.08 mm

### 2nd Trailing Laser Beam:

Laser Power: 100 W
Focal point relative to working plane: +15 mm
Point distance: 20 μm
Exposure time: 20 μs
Hatch distance: 0.08 mm

### 3rd Trailing Laser Beam:

Laser Power: 50 W
Focal point relative to working plane: +15 mm
Point distance: 20 μm
Exposure time: 20 μs
Hatch distance: 0.08 mm

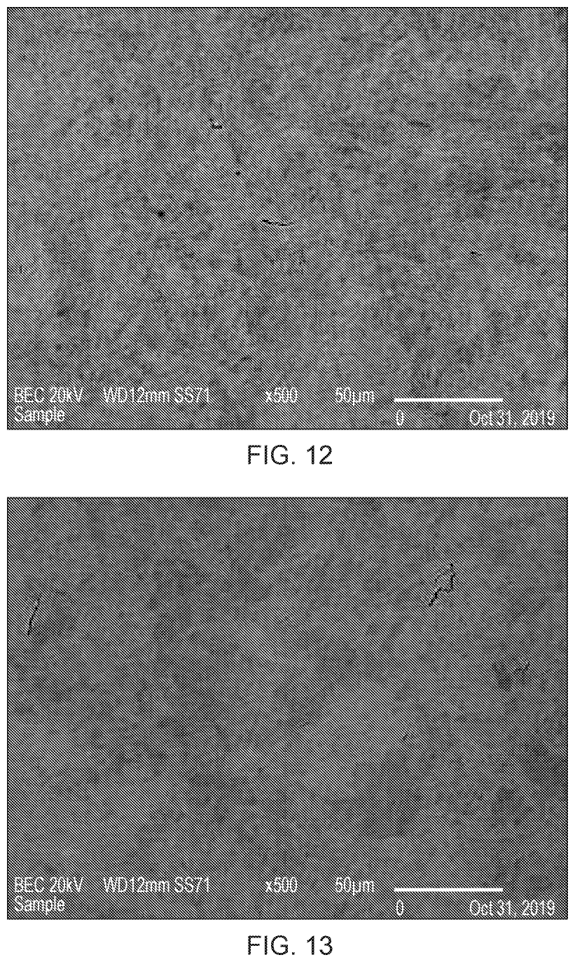

For a delay of 500 μs, a bulk density of 99.92% of the theoretical bulk density was achieved. For a delay of 1000 μs, a bulk density of 99.95% of the theoretical bulk density was achieved. For a delay of 1500 μs, a bulk density of 99.97% of the theoretical bulk density was achieved. As can be see from FIGS. 11, 12 and 13, a reduction in cracks can be observed compared to using a single laser beam to form a cube.

Again, an increase in hardness in these samples was observed compared to the cube formed using a single laser beam.

### Example 3

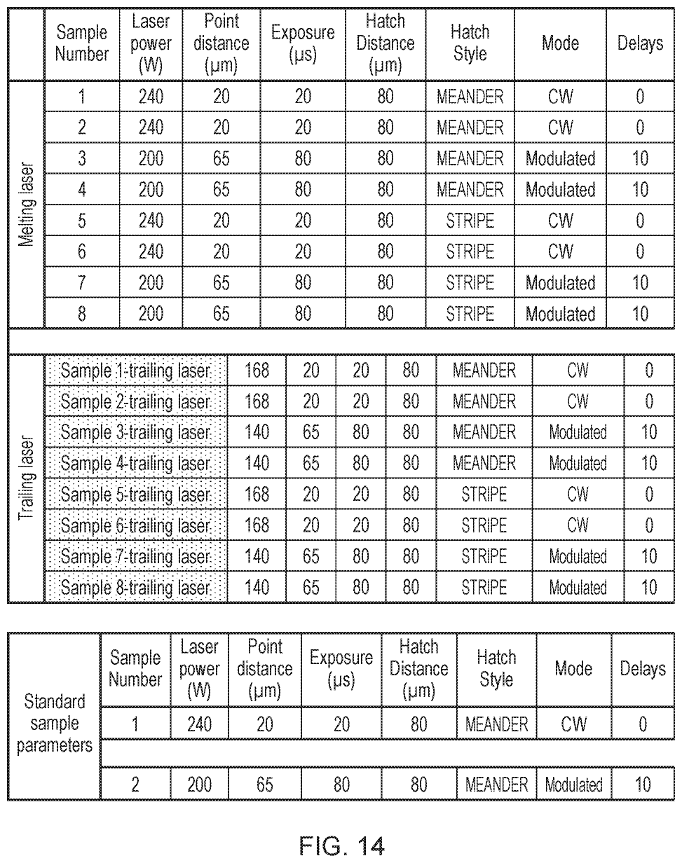

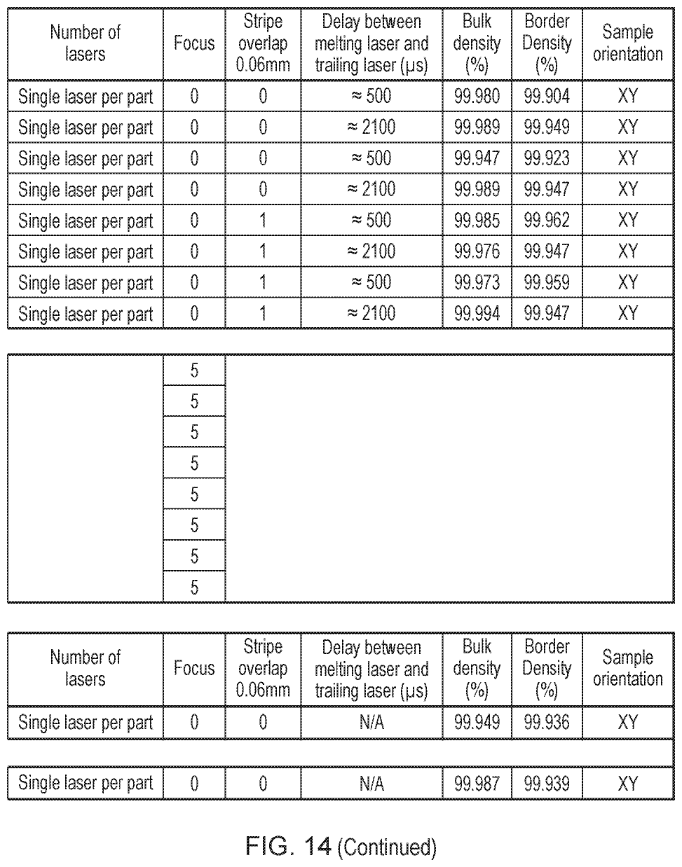

Eight 10 mm×10 mm×10 mm cubes were built from tool steel W360 powder in a RenAM 500Q additive manufacturing machine. The cubes were built using leading and trailing laser beams, which traversed the cross-sections in a meander or stripe scan strategy. The hatch direction was rotated every layer by 67 degrees. No preheating of the powder was carried out using the heater in the build platform. Two cubes were built using a single laser beam. The scan parameters used for each cube is set out in FIG. 14.

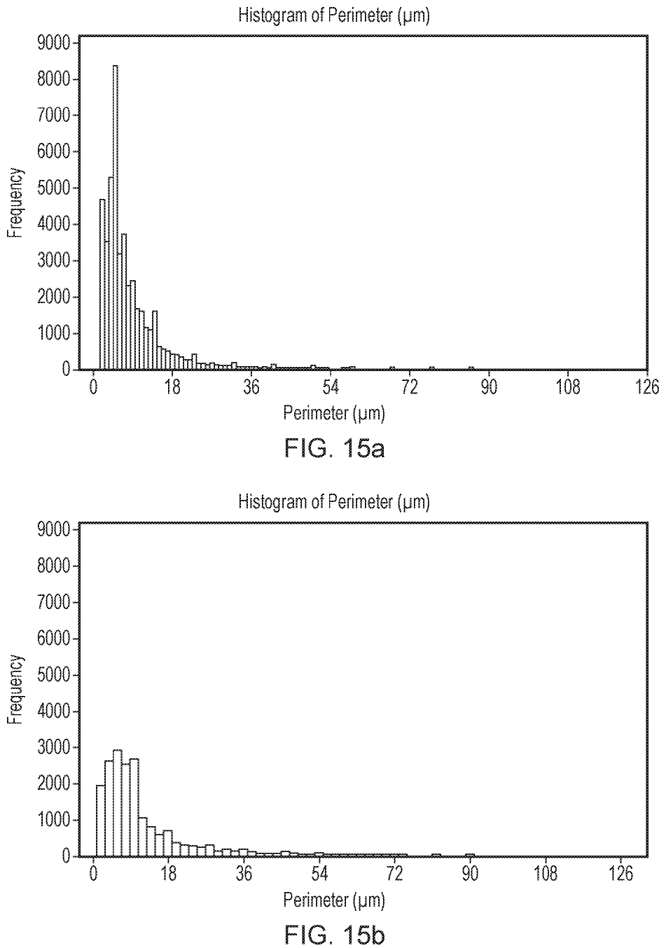

A number of cracks in each cube was counted using a computer programme that automatically identifies cracks from an optical image of cross-sections of the cubes. FIG. 15 is a histogram showing the number of cracks identified as having a particular perimeter size of the cubes built using a single laser beam and FIG. 15b is a histogram showing the number of cracks identified as having a particular perimeter size of the cubes built using leading and trailing laser beams. As is apparent from the histograms, a number of cracks is lower in the cubes built using leading and trailing laser beams compared to the cubes built using a single laser beam.

### Example 4

A 10 mm×10 mm×10 mm cube was built from tool steel HS13 powder in a Renishaw RenAM500Q HT additive manufacturing machine, wherein the powder bed was heated to 500° C. The cube was built using a single laser using a meander scan strategy, wherein the hatch direction was rotated every layer by 67 degrees.

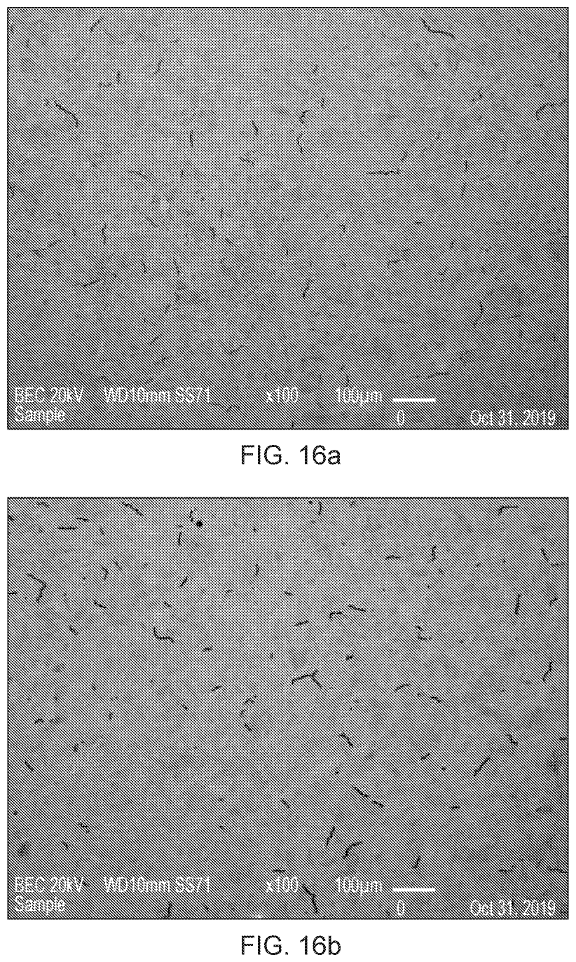

FIGS. 16a and 16b is an electron backscattered image of two-cross-sections of the cube. As can be see, many cracks are present in the cube.

It is believed that Example 4 illustrates that reduced cooling rates do not prevent the formation of cracks in H13 tool steel.

### Example 5

Cubes were built in H13 tool steel, one using leading and trailing laser beams, wherein the trailing laser beam trailed by 2500 μs and another with a single laser beam only. There was no preheating of the powder bed. The following scan parameters were used:

### Leading Laser Beam:

Laser Power: 240 W
Focal point relative to working plane: 0 mm
Point distance: 20 μm
Exposure time: 20 μs
Hatch distance: 0.08 mm

### Trailing Laser Beam:

Laser Power: 100 W
Focal point relative to working plane: +5 mm
Point distance: 20 μm
Exposure time: 20 μs
Hatch distance: 0.08 mm

For the single laser beam the same scan parameters used are those listed above for the leading laser beam.

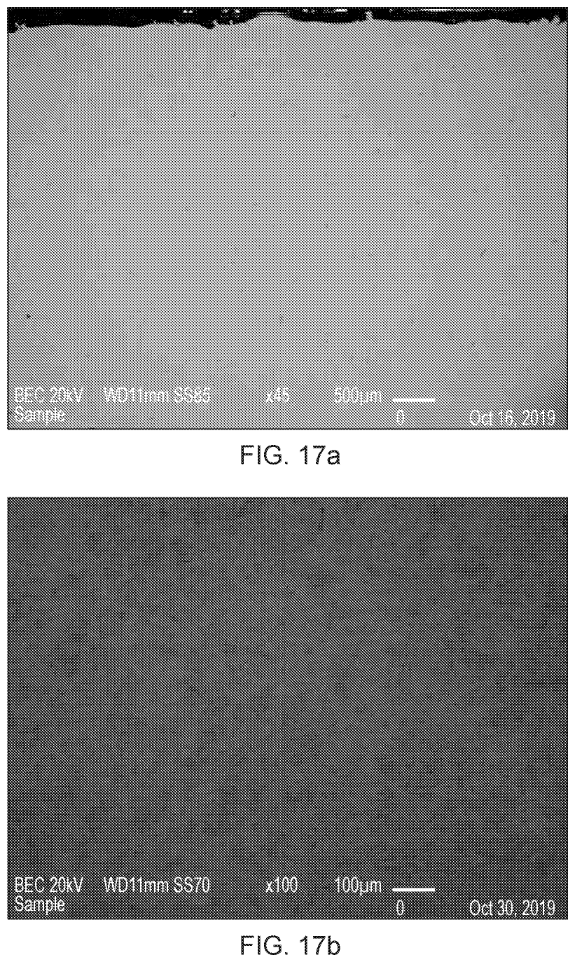

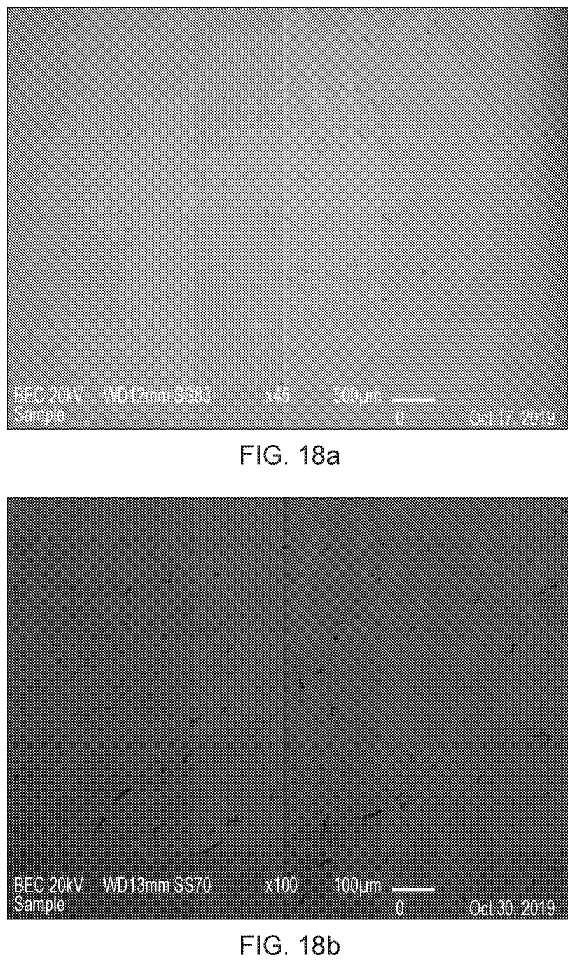

FIG. 17a is a back-scattered electron image of a cross-section of the cube formed using the leading and trailing laser beams. FIG. 18a is a back-scattered electron image of a cross-section of the cube formed using the single laser beam. As can be seen from the images, the number and size of cracks present in the fused material has reduced using leading and trailing laser beams compared to the cube formed using a single laser beam. FIGS. 17b and 18b shows images of cross-sections of the cubes at higher resolution that have undergone a crack analysis using software. The crack area percentage of the cross-section formed using leading and trailing laser beams was 0.05%, the average crack length was 16+/−12 μm and the average crack width was 0.5+/−0.5 μm. The crack area percentage of the cross-section formed using a single laser beam was 0.26%, the average crack length was 25+/−15 μm and the average crack width was 2+/−1 μm.

### Example 6

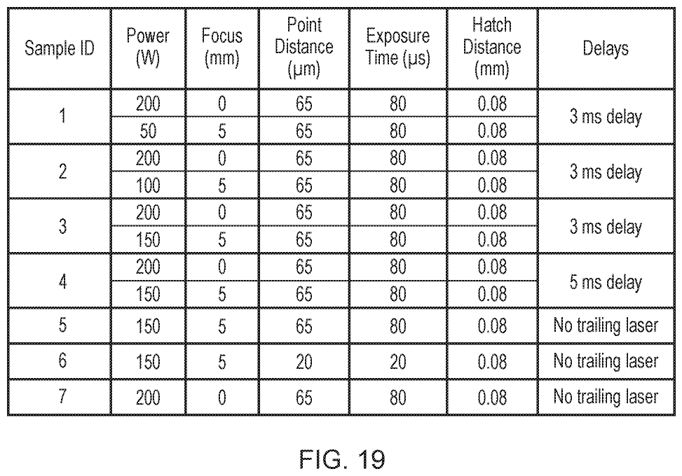

Cubes were built from M2 high-speed steel, four cubes built using leading and trailing laser beams and three with a single laser beam only. The scan parameters used are set out in FIG. 19. Hatch lines were also formed on top of each cube with the scan parameters to allow study of the melt region.

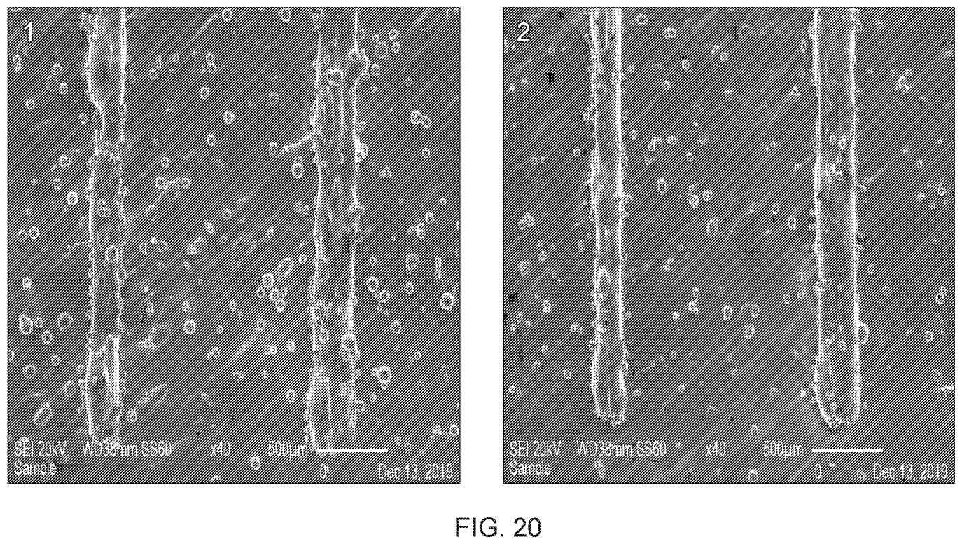

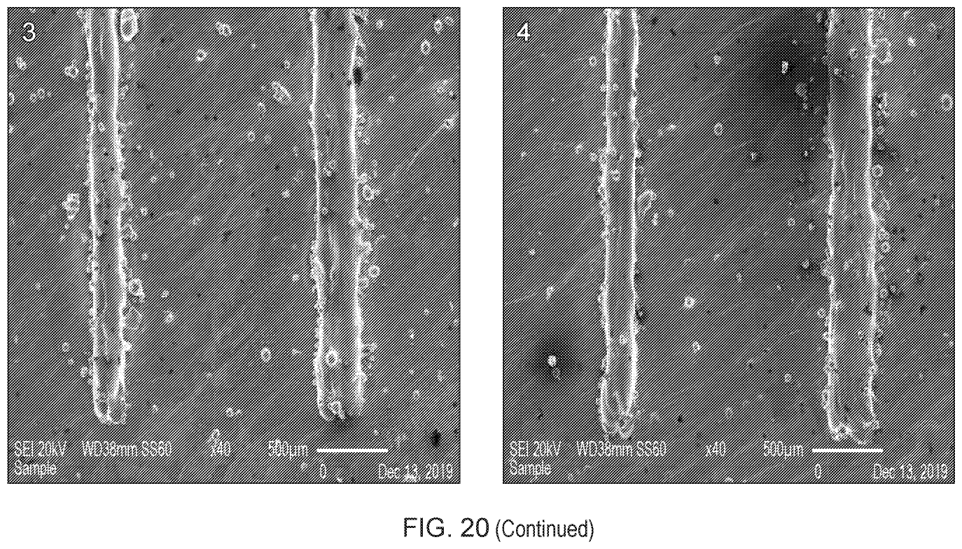

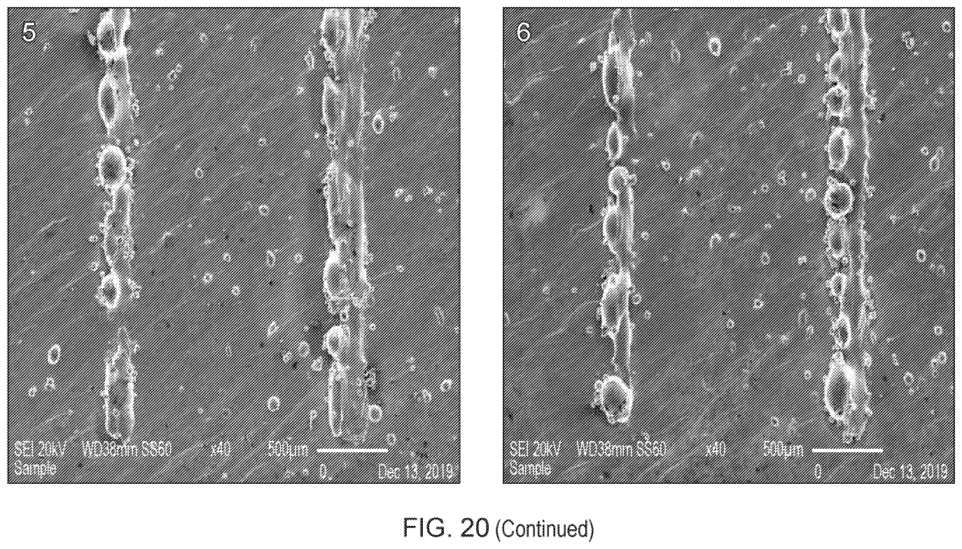

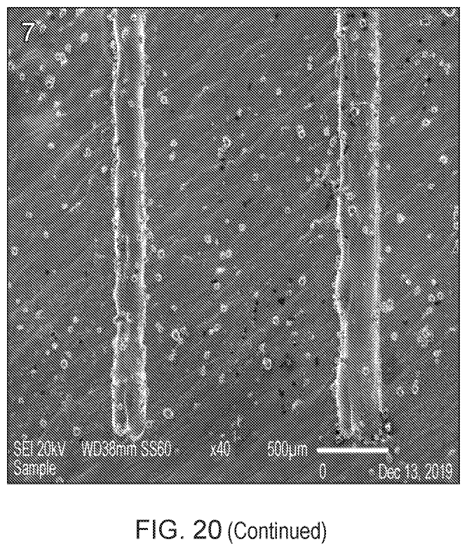

FIGS. 20-1 to 20-7 correspond to the sample number set out in the table of FIG. 19. As can seen from the hatch lines visible in FIGS. 20-1 to 20-4 the smoothness of the hatch lines increases with increase in laser power of the trailing laser from 50 W to 150 W, indicating an increase in remelting as the power in increased. FIGS. 20-5 and 20-6 show balling effects when using the single laser beam with lower power, illustrating these scan parameters of the trailing laser beam are insufficient without the leading laser beam to melt a continuous line of the material.

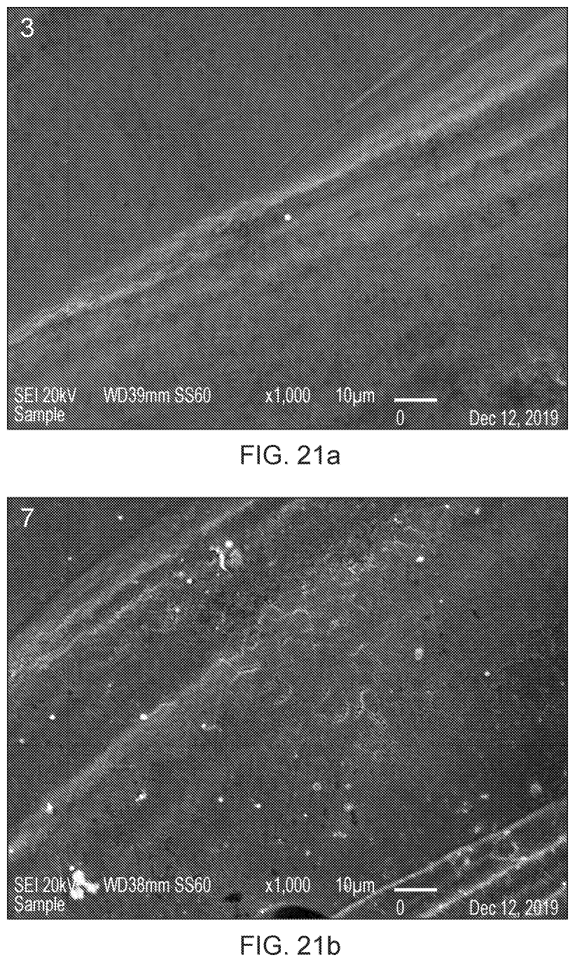

FIG. 21a show the top surface of a cube built using leading and trailing laser beams showing the refined microstructure. FIG. 21b show the top surface of a cube built using a single laser beam showing coarse dendrites and significantly more cracks.

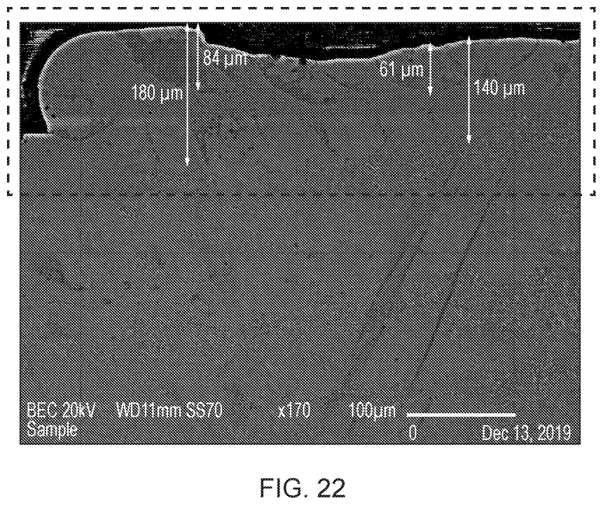

The dotted box denoted in FIG. 22 encloses a single layer melted with leading and trailing laser beams in M2 high-speed steel. The hatch direction is normal to the page. As can be seen, the layer has been formed from deeper melt pools having a keyhole mode shape created by the leading laser beam and shallow melt pools having a conduction mode shape created by the trailing laser beam. This is an indication that remelting is being carried out by the trailing laser beam despite the scan parameters providing too low an energy density to melt the material without the heating carried out the leading laser beam.

It will be understood that alterations and modifications can be made to the above described embodiments without departing from the scope of the invention as defined herein. For example, rather than a continuous scanning of the irradiation paths 201, 401a, 401b by the laser beams, each or one or more of the laser beams may be modulated to irradiate a series of points or section along the irradiation path. Rather than applying the scanning strategy to only the fill scan or to both the fill scan and the border scan, the scanning strategy may be applied to the border scans only. Cracks during part failure tend to be initiated from microcracks at a surface of the part. Accordingly, reducing or eliminating cracks at the border may be sufficient to provide a part having the required mechanical properties. Furthermore, it may be more difficult to ensure that a melt of the material at the border is as required, whereas the required conditions may be easier to maintain within the core of a cross-section. Accordingly, a required mechanical property, such as grain orientation, may be achievable within the core on melting the material without grain refinement but a grain refinement may be required for the fused material at the borders.

1. A powder bed fusion additive manufacturing method in which an object is built in a layer-by-layer manner, the method comprising, for each layer of a plurality of successively fused layers, melting material of the layer by irradiating the layer with one or more energy beams a first time using a first set of irradiation parameters and allowing the melted material to solidify to define a fused region of the layer and reheating the fused region by irradiating the layer a subsequent time with one or more of energy beams using a second set of irradiation parameters, wherein the first set of irradiation parameters comprises at least one different irradiation parameter to the second set of irradiation parameters.

2. A powder bed fusion additive manufacturing method according to claim 1, wherein the reheating increases a temperature of the fused region above a temperature at which grain refinement occurs, wherein the grain refinement may reduce an amount of epitaxial and/or columnar grains.

3. A powder bed fusion additive manufacturing method according to claim 2, wherein the temperature is a tempering temperature at which tempering of the fused material occurs, an annealing temperature at which annealing of the fused material occurs, a solution heat treatment temperature at which a solution heat treatment of the fused material occurs, a sintering temperature at which sintering of the fused material occurs or a melting temperature at which melting of the fused material occurs.

4. A powder bed fusion additive manufacturing method according to claim 1, wherein the reheating increases a temperature of the fused region by at least 100° C., 200° C., 300° C., 400° C. or 500° C.

5. A powder bed fusion additive manufacturing method according to claim 1, wherein reheating of the fused region is carried out after the fused region has cooled to below 350° C.

6. A powder bed fusion additive manufacturing method according to claim 1, comprising reheating the fused region more than one subsequent time.

7. A powder bed fusion additive manufacturing method according to claim 1, wherein a separation between the first time and the subsequent time may be greater than 250 microseconds.

8. A powder bed fusion additive manufacturing method according to claim 1, wherein the same irradiation pattern is used for irradiating the material the first time and the or each subsequent time.

9. A powder bed fusion additive manufacturing method according to claim 1, wherein irradiating material of each layer the first time comprises progressively irradiating a predefined irradiation path with a first, leading energy beam and irradiating the fused region the or each subsequent time comprises progressively irradiating the predefined irradiation path with a trailing energy beam.

10. A powder bed fusion additive manufacturing method according to claim 9, wherein the leading energy beam has a different power to the trailing energy beam and/or a spot size the same as or larger than the leading energy beam and/or the trailing energy beam irradiates an area the same width or wider than a fused line of material formed by the progression of the leading energy beam along the irradiation path.

11. A powder bed fusion additive manufacturing method according to claim 1, wherein a different irradiation pattern is used for irradiating the layer the first time and the or each subsequent time.

12. A powder bed fusion additive manufacturing method according to claim 11, wherein the further irradiation pattern is arranged to produce a preferential direction of grain formation.

13. A powder bed fusion additive manufacturing method according to claim 1, comprising the reheating comprises melting of the fused region the or each subsequent time such that the melt pool(s) formed extend deeper than the melt pool(s) formed when melting material of the layer the first time to form the fused region.

14. A powder bed fusion additive manufacturing method in which an object is built in a layer-by-layer manner, the method comprising, for each layer of a plurality of successively fused layers, melting material of the layer using a leading energy beam by progressing the energy beam over the material along an irradiation path, allowing the melted material to solidify and reheating the solidified material by progressing a trailing energy beam along the irradiation path.

15. A powder bed fusion additive manufacturing method in which an object is built in a layer-by-layer manner, the method comprising, for each layer of a plurality of successively fused layers, melting material of the layer a first time by irradiating the layer in a first irradiation pattern with one or more energy beams, allowing the melted material of the pattern to solidify to define a fused region of the layer and melting the fused region a subsequent time in a second irradiation pattern with one or more energy beams.
